(19) United States
(12) Patent Application Publication
(10) Pub. No.: US 2025/0145817 A1
(43) Pub. Date: May 8, 2025

(54) Hybrid Starch/PVOH Water-Soluble Film Including Salts

(71) Applicant: MONOSOL, LLC, Merrillville, IN (US)

(72) Inventors: Dmitriy Davydovich, Merrillville, IN (US); Nicholas Alan Nelson, Hammond, IN (US); Ramaswamy Ramaswamy, Merrillville, IN (US)

(21) Appl. No.: 18/938,817

(22) Filed: Nov. 6, 2024

Related U.S. Application Data
(60) Provisional application No. 63/596,861, filed on Nov. 7, 2023.

(51) Int. Cl. C08L 29/04; C08J 3/21; C08J 5/18; C08K 3/16; C08K 5/31

(52) U.S. Cl. CPC C08L 29/04; C08J 3/212; C08J 5/18; C08K 3/16; C08K 5/31; C08J 2329/04; C08J 2403/08; C08K 2003/166; C08L 2203/16; C08L 2205/06; C08L 2205/08

(57) ABSTRACT

A water-soluble film comprising a mixture of a polyvinyl alcohol resin, a starch, and a salt, wherein the salt is present in the water-soluble film in an amount sufficient to improve compatibility of the polyvinyl alcohol resin and the starch.

### CROSS-REFERENCE TO RELATED APPLICATION

The benefit under 35 U.S.C. § 119(e) of U.S. Provisional Patent Application No. 63/596,861, filed Nov. 7, 2023, is claimed and the entire disclosure thereof is incorporated herein by reference.

### FIELD

The present disclosure relates generally to water-soluble films and related articles. More particularly, the disclosure relates to water-soluble films, including water-soluble films comprising a blend of a polyvinyl alcohol resin and a starch, further containing one or more salts.

### BACKGROUND

Water-soluble polymeric films are commonly used as packaging materials to simplify dispersing, pouring, dissolving, and dosing of a material to be delivered. For example, pouches made from water-soluble film are commonly used to package household care compositions such as laundry and dish detergents for personal care needs. A consumer can directly add the pouched composition to a mixing vessel, such as a bucket, sink, or a washing machine, such as for laundry or dishes. Advantageously, this provides for accurate dosing while eliminating the need for the consumer to measure the composition. Use of an article containing multiple compositions, such as an article containing a laundry or dish detergent or other cleaning solvents and one or more additional compositions (for example, a softener, brightener, or fragrance aid) in different compartments, can eliminate the need to separately add multiple products. The pouched composition may also reduce mess that would be associated with dispensing a similar composition from a vessel, such as pouring a composition from a bottle. In sum, soluble pre-measured polymeric film pouches provide for convenience of consumer use in a variety of applications.

Pouches comprising water-soluble films can be produced, for example, by thermoforming. Thermoforming a film is a process of heating the film, shaping the film (for example, in a mold), and allowing the film to cool, whereupon the film will hold its shape, e.g., the shape of the mold. Reducing the temperature at which a water-soluble film can be thermoformed can enable improvements in production cost and throughput, for instance by reducing energy requirements and reducing heating and cooling times. However, such improvements should not be made at the expense of film properties that are relevant to making or using the pouch, such as acceptable mechanical strength, flexibility, and solubility.

Many consumers are increasingly inclined to use environmentally friendly or renewable products. Many conventional water-soluble films are made from materials that are generally not environmentally friendly or renewable and typically have a low renewable carbon index (RCI). Moreover, many renewable components form stiff or brittle films and have low miscibility or compatibility with other polymeric components of conventional water-soluble films, and accordingly the use of renewable components in water-soluble films has been limited, due to a need for such films to exhibit mechanical properties (for instance, deformation recovery, a high degree of elongation, and strength properties) suitable for conversion into and use as packages.

Altering the properties of a polymer film by addition of one or more metal salts has been reported. In particular, several authors have noted that addition of metal salts to a polymer film can have a plasticizing effect, as generally evidenced by decreasing glass transition temperature (Tg) of the film with increasing metal salt content. For instance, Jiang et al. (Carbohydrate Polymers, 90 (2012) 1677-1684; Intl. Journal of Biological Macromolecules, 82 (2016) 223-230) describe plasticization of starch/polyvinyl alcohol films by addition of various metal chloride salts. Some of the added salts had a detrimental impact on water sorption or thermal stability.

Bhajantri et al. (Polymer, 47 (2006) 3591-3598) describe the effects of barium chloride doping on optical, thermal, and structural properties polyvinyl alcohol films. The authors concluded that the dopant acted as a plasticizer but that high dopant concentrations led to phase separation into polymer-rich and dopant-rich phases.

Zidan (J. Appl. Polym. Sci., 88 (2003) 1115-1120) describes thermal properties of chromium fluoride- and manganese chloride-filled PVOH films. In general, increasing filler content reduced Tg and degradation temperature of the films, and the author concluded that the fillers acted to plasticize the films.

### SUMMARY

One aspect of the disclosure provides a water-soluble film comprising a mixture of a polyvinyl alcohol resin, a starch, and a salt, wherein the salt is present in the water-soluble film in an amount sufficient to improve the compatibility ratio of the polyvinyl alcohol resin and the starch, as determined according to the Compatibility Test Method, relative to the compatibility ratio of the polyvinyl alcohol resin and the starch in the absence of the salt.

Another aspect of the disclosure provides a water-soluble article comprising the water-soluble film according to the disclosure.

Another aspect of the disclosure provides an aqueous mixture comprising a polyvinyl alcohol resin, a starch, a salt, and water, wherein the salt is present is an amount sufficient to improve the compatibility ratio of the polyvinyl alcohol resin and the starch, relative to the compatibility ratio of the polyvinyl alcohol resin and the starch in an otherwise identical aqueous mixture not containing the salt.

Another aspect of the disclosure provides a method of compatibilizing a polyvinyl alcohol and a starch in an aqueous mixture, the method comprising adding to the aqueous mixture a salt, wherein the salt is added in an amount sufficient to improve the compatibility ratio of the polyvinyl alcohol resin and the starch in the aqueous mixture, relative to the compatibility ratio of the polyvinyl alcohol and the starch in an otherwise identical aqueous mixture not containing the salt.

For the compositions and methods described herein, optional features, including but not limited to components, compositional ranges thereof, substituents, conditions, and steps are contemplated to be selected from the various aspects, embodiments, and examples provided herein.

Further aspects and advantages will be apparent to those of ordinary skill in the art from a review of the following detailed description, taken in conjunction with the drawings. While the film, article, pouch, and their methods of making and use are susceptible of embodiments in various forms, the description hereafter includes specific embodiments with the understanding that the disclosure is illustrative, and is not intended to limit the invention to the specific embodiments described herein.

### DETAILED DESCRIPTION

The disclosure provides a water-soluble film comprising a mixture of a polyvinyl alcohol resin, a starch, and a salt, wherein the salt is present in the water-soluble film in an amount sufficient to improve the compatibility ratio of the polyvinyl alcohol resin and the starch, as determined according to the Compatibility Test Method, relative to the compatibility ratio of the polyvinyl alcohol resin and the starch in the absence of the salt.

The disclosure also provides an aqueous mixture comprising a polyvinyl alcohol resin, a starch, a salt, and water, wherein the salt is present is an amount sufficient to improve the compatibility ratio of the polyvinyl alcohol resin and the starch, relative to the compatibility ratio of the polyvinyl alcohol resin and the starch in an otherwise identical aqueous mixture not containing the salt.

The disclosure also provides a method of compatibilizing a polyvinyl alcohol and a starch in an aqueous mixture, the method comprising adding to the aqueous mixture a salt, wherein the salt is added in an amount sufficient to improve the compatibility ratio of the polyvinyl alcohol resin and the starch in the aqueous mixture, relative to the compatibility ratio of the polyvinyl alcohol and the starch in an otherwise identical aqueous mixture not containing the salt.

“Comprising” as used herein means that various components, ingredients, or steps that can be conjointly employed in practicing the present disclosure. Accordingly, the term “comprising” encompasses the more restrictive terms “consisting essentially of” and “consisting of.” The present compositions can comprise, consist essentially of, or consist of any of the required and optional elements disclosed herein. The invention illustratively disclosed herein suitably may be practiced in the absence of any element or step which is not specifically disclosed herein.

Films, such as those made in accordance with the disclosure, are defined by the polymer industry (Encyclopedia of Polymer Science and Technology, John Wiley & Sons, Inc., 1967, Vol. 6, page 764) as “shaped plastics that are comparatively thin in relation to their breadth and width and have a maximum thickness of 0.010 in.”

The films of the disclosure can be self-supporting films and/or uniform films. Self-supporting films are those capable of supporting their own weight. Uniform films refer to those which are virtually free of breaks, tears, holes, bubbles, and striations.

To be considered a water-soluble film according to the present disclosure, the film, at a thickness of about 1.5 mil (about 0.038 mm), dissolves in 300 seconds or less in water at a temperature of 20° C. (68° F.) in accordance with MonoSol Test Method MSTM 205. A film according to the present disclosure can be considered water-soluble if the film, at a thickness of about 1.5 mil (about 0.038 mm), dissolves in 250 seconds or less, 200 seconds or less, or 150 seconds or less, in water at a temperature of 20° C. (68° F.) in accordance with MonoSol Test Method MSTM 205.

All percentages, parts and ratios are based upon the total dry weight of the formed film composition and all measurements are made at about 25° C., unless otherwise specified. All such weights as they pertain to listed ingredients are based on the active level and therefore do not include carriers or by-products that may be included in commercially available materials, unless otherwise specified.

All ranges set forth herein include all possible subsets of ranges and any combinations of such subset ranges. By default, ranges are inclusive of the stated endpoints, unless stated otherwise. Where a range of values is provided, it is understood that each intervening value between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also contemplated to be part of the disclosure.

The dimensions and values disclosed herein are not to be understood as being strictly limited to the exact numerical values recited. Instead, unless otherwise specified, each such dimension is intended to include both the recited value and a functionally equivalent range surrounding that value. For example, a dimension disclosed as “15 mm” is intended to include “about 15 mm”. The term “about” is used according to its ordinary meaning, for example, to mean approximately or around. The term “about” can mean±10% of a stated value or range of values. The term “about” can mean±5% of a stated value or range of values. The term “about” can mean±2% of a stated value or range of values.

As used herein and unless specified otherwise, the terms “wt. %” and “wt %” are intended to refer to the composition of the identified elements in “dry” (non-water) parts by weight of the entire film (when applicable) or parts by weight of the entire composition enclosed within a pouch (when applicable).

As used herein and unless specified otherwise, the term “PHR” (“phr”) refers to the composition of the identified element in parts per one hundred parts water-soluble polymer resin (whether polyvinyl alcohol or other polymer resins, unless specified otherwise) in the water-soluble film, or a solution used to make the water-soluble film. For films or solutions containing polyvinyl alcohol and starch, “water-soluble polymer resin” includes polyvinyl alcohol and starch, unless specified otherwise.

The film can be made by a solution casting method. The film can be used to form an article or a pouch by any suitable process, including thermoforming and, for example, solvent sealing or heat sealing of film layers around a periphery of the article. The pouches can be used for dosing materials to be delivered into bulk water, for example.

“Renewable Carbon Index” (“RCI”) as used herein refers to the fraction, or percentage, of the carbon atoms in the average structure of a material (for example, a solvent, surfactant, or polymer, or a film or other article) that are derived from feedstocks other than petroleum or natural gas feedstocks. Typically, and desirably, when components of water-soluble films are produced from natural materials or in a sustainable manner, the RCI will be in excess of 0.75 or 75%, due to the use of materials found in nature and/or the use of feedstocks derived from sustainable sources such as plants, fungi, or algae; products of bacterial fermentation processes; or products of treatments of plant-, fungal- or algae-derived biomass. Challenges in the formulation of water-soluble films with desirably high RCIs include a limited selection of low-RCI materials that are economically viable and deliver performance comparable to or better than conventional (i.e., non-naturally occurring or non-sustainable) materials.

The films, articles, and related methods of making and use are contemplated to include embodiments including any combination of one or more of the elements, features, and steps further described below (including those shown in the Examples), unless stated otherwise.

### Water-Soluble Films

The film and related articles and pouches described herein can comprise a water-soluble film containing a salt, wherein the salt is distributed throughout the film or article. The water-soluble film can be solution cast. The films optionally further include one or more additives selected from plasticizers, fillers, surfactants, anti-block agents, antioxidants, antifoams, bleaching agents, aversive agents, pungents, other functional ingredients, and combinations of the foregoing.

The surfaces of the film, and related articles and pouches comprising the film, can be substantially free of salt. As used herein, a surface of a film is substantially free of salt if the film comprises less than 5 wt % of salt on the surface, based on the total weight of the film. Additionally or in the alternative, a surface of a film is substantially free of salt if a layer external to the film (defined as a layer extending from an external surface of the film and into the film to no more than a depth of 10% of the thickness of the film) contains salt in a concentration not exceeding 50 wt. % of the external layer. Accordingly, the surfaces of the film, and related articles and pouches comprising the film, can be substantially free of cations and/or anions comprising the salt.

The film can have any suitable thickness, and film thicknesses of about 76 microns (μm) or 88 microns are typical and particularly contemplated. Other values and ranges contemplated include values in a range of about 5 to about 200 μm, or in a range of about 20 to about 100 μm, or about 60 to about 120 μm, or about 70 to about 100 μm, or about 40 to about 90 μm, or about 50 to about 80 μm, or about 60 to about 65 μm, or about 20 to about 60 μm, or about 20 to about 50 μm, or about 30 to about 40 μm, for example about 35 μm, about 36 μm, about 50 μm, about 65 μm, about 76 μm, about 88 μm, or about 90 μm.

The water-soluble film can have any renewable carbon index (RCI), for example, an RCI of at least about 30%, about 40%, about 50%, about 55%, about 60%, about 65%, about 70%, or about 80%, or within a range formed by any such values as endpoints, for example, in a range of about 50% to about 90%, or about 50 to about 80%.

The water-soluble film can dissolve in water leaving a residue of less than about 10 wt. %, less than about 5.0 wt. %, less than about 4.0 wt. %, less than about 3.0 wt. %, less than about 2.5 wt. %, or less than about 2.0 wt. % by weight of the water-soluble film at a temperature of about 15° C. according to the Accelerated Quantitative Residue Assessment test method described below. The residue can be measured at a temperature of about 15° C., e.g., leaving a residue of less than 5.0 wt. % by weight of the water-soluble film at a temperature of about 15° C.

### PVOH Resins

The film described herein can include one or more polyvinyl alcohol (PVOH) polymers to make up the PVOH resin content of the film, and can include a PVOH copolymer resin.

Polyvinyl alcohol is a synthetic resin generally prepared by the alcoholysis, usually termed hydrolysis or saponification, of polyvinyl acetate. Fully hydrolyzed PVOH, where virtually all the acetate groups have been converted to alcohol groups, is a strongly hydrogen-bonded, highly crystalline polymer which dissolves only in hot water—greater than about 140° F. (about 60° C.). If a sufficient number of acetate groups are allowed to remain after the hydrolysis of polyvinyl acetate, that is, the PVOH polymer is partially hydrolyzed, then the polymer is more weakly hydrogen-bonded, less crystalline, and is generally soluble in cold water—less than about 50° F. (about 10° C.). As such, the partially hydrolyzed polymer is a vinyl alcohol-vinyl acetate copolymer that is a PVOH copolymer, but is commonly referred to as PVOH homopolymer.

The PVOH resin can comprise a fully or partially hydrolyzed homopolymer that includes a vinyl alcohol monomer unit and optionally a vinyl acetate monomer unit. The PVOH resin can include a partially or fully hydrolyzed PVOH copolymer that includes an anionic monomer unit (i.e., an anionic-modified copolymer), a vinyl alcohol monomer unit, and optionally a vinyl acetate monomer unit. The anionic monomer unit can be one or more of vinyl acetic acid, alkyl acrylates, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, itaconic acid, monomethyl itaconate, dimethyl itaconate, itaconic anhydride, citraconic acid, monoalkyl citraconate, dialkyl citraconate, citraconic anhydride, mesaconic acid, monoalkyl mesaconate, dialkyl mesaconate, glutaconic acid, monoalkyl glutaconate, dialkyl glutaconate, glutaconic anhydride, vinyl sulfonic acid, alkyl sulfonic acid, ethylene sulfonic acid, 2-acrylamido-1-methyl propane sulfonic acid, 2-acrylamide-2-methylpropanesulfonic acid, 2-methylacrylamido-2-methylpropanesulfonic acid, 2-sulfoethyl acrylate, alkali metal salts of the foregoing (e.g., sodium, potassium, or other alkali metal salts), esters of the foregoing (e.g., methyl, ethyl, or other C₁-C₄ or C₆ alkyl esters), and combinations of the foregoing (e.g., multiple types of anionic monomers or equivalent forms of the same anionic monomer). For example, the anionic monomer can include one or more of monomethyl maleate and alkali metal salts thereof (e.g., sodium salts). The anionic monomer unit can be present in an anionic-modified PVOH copolymer in an average amount in a range of about 0.5 mol. % to about 10 mol. %, or about 1 mol. % to about 8 mol. %, or about 2 mol. % to about 5 mol. %.

The water-soluble film can comprise a single PVOH resin or a blend of two or more PVOH resins. For example, the film can comprise a PVOH homopolymer, a PVOH copolymer, a blend of a PVOH homopolymer and a PVOH copolymer, a blend of two or more PVOH homopolymers, a blend of two or more PVOH copolymers, or a combination thereof. The two or more PVOH homopolymers can be different in terms of viscosity, degree of hydrolysis, or a combination thereof. The two or more PVOH copolymers can be anionic-modified PVOH copolymers and can be different in terms of viscosity, degree of hydrolysis, type of anionic monomer unit, amount of anionic modification, or a combination thereof. The film can comprise a PVOH homopolymer or a blend of PVOH homopolymers as the only PVOH resins. The total amount of PVOH resin in the film can be in a range of about 10% to about 95% by weight based on the total weight of the film, or about 30% to about 90%, or about 50% to about 90%, or about 60% to about 90%, or about 65% to about 85%, for example.

The total PVOH resin content of the film can have a degree of hydrolysis (D.H. or DH) of at least about 68%, 75%, 80%, 84%, or 85% and at most about 99.7%, 98%, or 96%, for example in a range of about 75% to about 96%, or about 84% to about 90%, or about 85% to about 88%, or about 86.5%, or in a range of about 88% to 95%, about 89% to 93%, or about 89.5% to 92%, for example, about 89%, about 90%, about 92%, about 93%, about 94%, about 95%, or about 96%. As used herein, the degree of hydrolysis is expressed as a mole percentage of vinyl acetate units converted to vinyl alcohol units.

The degree of hydrolysis of a resin blend can also be characterized by the arithmetic weighted, average degree of hydrolysis (H̅^̅{̅o̅}̅). For example, H̅^̅{̅o̅}̅ for a PVOH resin that comprises two or more PVOH polymers is calculated by the formula H̅^̅{̅o̅}̅=Σ(Wᵢ·Hᵢ) where Wᵢ is the weight percentage of the respective PVOH polymer and Hᵢ is the respective degrees of hydrolysis.

The viscosity of a PVOH resin (p) is determined by measuring a freshly made solution using a Brookfield LV type viscometer with UL adapter as described in British Standard ENISO 15023-2:2006 Annex E Brookfield Test method. It is international practice to state the viscosity of 4% (w/v) aqueous polyvinyl alcohol solutions at 20° C. All viscosities specified herein in centipoise (cP) should be understood to refer to the viscosity of 4% (w/v) aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

Suitable PVOH resins, for use individually or in combinations, can have viscosities in a range of about 3 cP to about 40 cP, or about 5 cP to about 38 cP, or about 10 cP to about 36 cP, or about 10 cP to about 20 cP, or about 12 cP to about 20 cP, or about 14 cP to about 19 cP, or about 3 cP to about 30 cP, or about 5 cP to about 25 cP, or about 5 cP to about 15 cP, or about 5 cP to about 10 cP, or about 5 cP to about 7 cP, or about 12 cP to about 34 cP, or about 14 cP to about 32 cP, or about 18 cP to about 30 cP, about 20 cP to about 28 cP, about 21 cP to about 26 cP, for example, 32 cP, or 26 cP, or 23.5 cP, or 21 cP, or 19 cP, or 16.5 cP, or 14 cP, or 6 cP. It is well known in the art that the viscosity of PVOH resins is correlated with the weight average molecular weight (M̅_{W}) of the PVOH resin, and often the viscosity is used as a proxy for the M̅_{W}. When referring to the viscosity of a PVOH resin comprising a PVOH polymer blend, the weighted natural log average viscosity (μ̅) is used. The μ̅ for a PVOH resin that comprises two or more PVOH polymers is calculated by the formula μ̅=eΣ^{W}^{ᵢ}^{·lnμ}^{ᵢ} where μ, is the viscosity for the respective PVOH polymers.

### Bio-Based PVOH

In general, a “bio-based” material is a material comprising carbon derived from biomass. Biomass refers to resources originating from living organisms that are not exhaustible resources, including renewable organic resources derived from organisms, excluding fossil- and petroleum-derived resources. Bio-based materials generally have a higher RCI relative to otherwise identical non-bio-based materials.

The PVOH resin in a film of the disclosure can include bio-based PVOH. Bio-based PVOH includes PVOH in which at least a portion of the carbon comprising the PVOH is derived from biomass. In particular, bio-based PVOH includes PVOH produced by hydrolysis or saponification of bio-based polyvinyl acetate or of a blend of polyvinyl acetates that includes a bio-based polyvinyl acetate. In turn, bio-based polyvinyl acetate includes polyvinyl acetate produced by polymerizing a bio-based vinyl acetate or a blend of vinyl acetates that includes a bio-based vinyl acetate. In general, bio-based vinyl acetate includes vinyl acetate for which at least a portion of the carbon comprising the vinyl acetate is derived from biomass. Vinyl acetate can be obtained, for instance, by a gas phase reaction of ethylene, acetic acid, and oxygen; bio-based vinyl acetate can refer to vinyl acetate for which at least a portion of the ethylene and/or acetic acid is derived from biomass. For instance, bio-based vinyl acetate includes vinyl acetate obtained by a reaction of ethylene, acetic acid, and oxygen in which at least a portion of the ethylene and/or at least a portion of the acetic acid is bio-based. Accordingly, bio-based PVOH includes PVOH in which a portion of the carbon comprising the PVOH is derived from bio-based ethylene and/or bio-based acetic acid.

Plants that can be a source of bio-based ethylene and/or bio-based acetic acid include, but are not limited to, potato, sweet potato, sugar beet, rice, wheat, palm oil, algae, corn, sugar cane, sorghum, and cassava. Similarly, bio-based acetic acid can be produced by a bioethanol route.

Bio-based PVOH can be characterized by a carbon-14 (¹⁴C) content. In general, biomass-derived resources have a greater abundance of ¹⁴C (i.e., the amount of ¹⁴C as a percent of total carbon content) relative to petroleum-derived resources. In particular, bio-based ethylene and acetic acid generally have higher abundances of ¹⁴C relative to petroleum-derived ethylene and acetic acid, and in turn bio-based PVOH generally has a higher abundance of ¹⁴C relative to PVOH that is completely petroleum-derived. Accordingly, the abundance of ¹⁴C in a polymer, such as a PVOH resin, can serve as a marker of the polymer's bio-based content. A material's ¹⁴C content can be measured by known means, for instance, by mass spectrometric methods.

The films of the disclosure can include bio-based PVOH, as described in U.S. Patent Application Publication No. 2023/0257491A1, U.S. Patent Application Publication No. 2023/0070770A1, and International Patent Application Publication WO 2022/034906A1, which are hereby incorporated by reference in their entirety. The PVOH resin comprising a film of the disclosure can comprise petroleum-derived PVOH, or bio-based PVOH, or a blend of petroleum-derived PVOH and bio-based PVOH. For a film comprising a blend of petroleum-derived PVOH and bio-based PVOH, the ratio of the amounts of petroleum-derived PVOH and bio-based PVOH is not particularly limited and can be, for instance, in a range of about 99:1 to about 1:99, or about 95:5 to about 5:99, or about 80:20 to about 20:80, or about 70:30 to about 30:70, or about 60:40 to about 40:60.

Other water-soluble polymers for use in addition to the PVOH resin in the film can include, but are not limited to polyacrylates, water-soluble acrylate copolymers, polyvinyl pyrrolidone, polyethyleneimine, pullulan, water-soluble natural polymers including, but not limited to, guar gum, gum Acacia, gum Arabic, agars, xanthan gum, carrageenan, pectin, amylopectin, alginic acid and salts thereof, and starch, water-soluble polymer derivatives including, but not limited to, modified starches, ethoxylated starch, hydroxyethylated starch, and hydroxypropylated starch, copolymers of the forgoing and combinations of any of the foregoing. Yet other water-soluble polymers can include polyalkylene oxides, polyacrylamides, polyacrylic acids and salts thereof, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, polymethacrylates, and combinations of any of the foregoing. The film can include a polyethyleneimine, a polyvinyl pyrrolidone, a polyalkylene oxide, a polyacrylamide, a cellulose ether, a cellulose ester, a cellulose amide, a polyvinyl acetate, a polyamide, a gelatin, a methylcellulose, a carboxymethylcellulose, a carboxymethyl cellulose salt, a dextrin, an ethylcellulose, a hydroxyethyl cellulose, a hydroxypropyl methylcellulose, a maltodextrin, a starch, a modified starch, guar gum, gum Acacia, gum Arabic, agars, xanthan gum, carrageenan, a polyacrylate, a polyacrylate salt, and a copolymer of any of the foregoing. Such water-soluble polymers, whether PVOH or otherwise, are commercially available from a variety of sources.

### Starch

The water-soluble film of the disclosure includes a starch, such as a water-soluble starch. The starch can comprise one or more starches selected from an unmodified starch, a nonionic group-modified starch, an anionic group-modified starch, and a cationic group-modified starch. The starch can comprise a nonionic group-modified starch. The starch can comprise a cationic group-modified starch.

Unmodified starches can comprise naturally derived polysaccharides consisting of anhydroglucose units with α-1,4 and α-1,6 glycosidic bonds resulting in linear or branched chains. The linear chains are known as amylose and the branched chains are known as amylopectin. Generally, starches with lower molecular weight and lower amounts of amylose are easier to gelatinize and dissolve in water. Unmodified starches can include starches having no chemical moieties added to the polysaccharide. For example, unmodified starches can include a starch that has had its molecular weight reduced by techniques such as acid hydrolysis.

The starch can have a cook % of at least about 5 wt. %, at least 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, at least about 25 wt. %, at least about 26 wt. %, at least about 27 wt. %, at least about 28 wt. %, at least about 29 wt. %, or at least about 30 wt. %, or in a related range, e.g. at least 10 wt. % and up to 40 wt. %, or at least 10 wt. % and up to 30 wt. %, for example. The starch can have a cook % of at least about 15 wt. %. As used herein, cook % is the maximum weight percentage of a starch dissolved in water after heating and mixing in water at 95° C. for 30 minutes.

The modified starch can comprise a physically modified starch, such as discrete amylose or amylopectin, or moist heat processed starch; enzyme-modified starch such as hydrolyzed dextrin, enzyme decomposed dextrin or amylose; chemically modified starch; or a combination thereof. Chemically modified starches can comprise chemically decomposed starch such as acid-treated starch, hypochlorous acid-oxidized starch or dialdehyde starch; non-ionic group-modified starch, including esterified starch and etherified starch; and/or ionic group-modified starch including anionic group-modified starch and cationic group-modified starch. Esterified starch can include acetic acid esterified starch, succinic acid esterified starch, nitric acid esterified starch, phosphoric acid esterified starch, urea-phosphoric acid esterified starch, xanthic acid esterified starch, acetoacetic acid esterified starch, and the like. Etherified starch can include allyl etherified starch, methyl etherified starch, carboxymethyl etherified starch, hydroxyethyl etherified starch, hydroxypropyl etherified starch, and the like. Non-limiting examples of the nonionic group-modified starch include hydroxyethyl- and hydroxypropyl-modified starch and octenyl succinic anhydride-modified starch.

The degree of modification of the modified starch can be in a range of about 0.01 to about 10 mol. %, about 0.05 to about 5 mol. %, about 0.05 to about 4 mol. %, about 0.05 to about 3 mol. %, about 0.05 to about 2 mol. %, about 0.05 to about 1 mol. %, about 0.1 to about 1 mol. %, about 0.1 to about 0.5 mol. %, about 0.1 to about 0.3 mol. %, about 0.05 to about 3.5 mol. %, about 1.0 to about 5.0 mol. %, or about 1 to about 3.5 mol. %, for example about 0.18 mol. % or 0.21 mol. %.

Molecular weight, amylose/amylopectin ratio, modification type, and modification level of a starch can significantly impact its cook %, the rheology of the resulting starch solution, and the interaction and miscibility of starch with other materials, such as polyvinyl alcohol. Unmodified starch directly extracted from a plant often has a cook % of only about 1-2%. Starch molecular weight can be reduced through acid hydrolysis, which can increase the maximum cook %. Certain types of chemical modifications to starch can increase cook %, inhibit retrogradation, and reduce starch solution viscosity. The 2^{nd} and/or 3^{rd} carbons of the glucose unit can be subject to modifications via reactions with, for example, secondary alcohols. Chemical modification can provide, for example, nonionic (e.g., hydroxyethyl, hydroxypropyl, octenyl), anionic (e.g., carboxyl), or cationic (e.g., trimethylammonium) modifications of the starch.

The starch can comprise substantially gelatinized starch.

The starch can have an average molecular weight in a range of about 10³-10⁶ g/mol, or about 10⁴-10⁵ g/mol.

The starch can have an amylose content in a range of about 0 to about 50 wt. %, about 0 to about 40 wt. %, about 0 to about 30 wt. %, or about 0 to about 25 wt. % of the starch.

The starch can have a 5 wt. % aqueous solution Brookfield viscosity in a range of about 1-2000 cP, about 1-1500 cP, about 1-1000 cP, about 1-900 cP, about 1-800 cP, about 1-700 cP, about 1-600 cP, about 1-500 cP, about 2-400 cP, about 2-300 cP, about 2-200 cP, or about 2-100 cP, at a shear rate of about 20 rpm and a temperature of about 87.8° C. (about 190° F.).

The starch can be present in an amount in a range of about 5 wt. % to about 95 wt. %, or about 10 wt. % to about 90 wt. %, or about 20 wt. % to about 80 wt. %, or about 30 wt. % to about 70 wt. %, by weight of the water-soluble film.

The water-soluble modified starch can comprise cationic group-modified starch. The cationic group-modified starch can include a cationic amine or ammonium group-modified starch, including a primary amine group-modified starch, a secondary amine group-modified starch, a tertiary amine group-modified starch, or a quaternary amine or ammonium group-modified starch. The cationic group-modified starch can comprise a quaternary ammonium group-modified starch. Non-limiting examples of quaternary ammonium group-modified starch include trimethylammonium group-modified starch, a starch modified by a 2-diethylaminoethyl halide salt, and a starch modified by a 2,3-epoxypropyltrimethylammonium halide salt.

The cationic group-modified starch can comprise a cationic quaternary ammonium group-modified starch, e.g., a starch having a structure of Formula A, wherein R¹, R², and R³ are each independently H, a C₁-C₁₀ alkyl group, or a C₁-C₁₀ hydroxyalkyl group, wherein R⁴ is a C₁-C₁₀ alkylene group, and wherein X is an ether or an ester linkage connecting R⁴ to the starch, or an oxygen-, nitrogen-, or sulfur-containing hydrocarbon group.

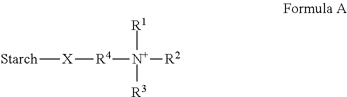

R¹, R² and R³ can be identical C₁-C₄ alkyl groups and R⁴ can be a C₁-C₆ hydroxyalkylene group. In another aspect, R⁴ can be a C₃-C₆ hydroxyalkylene group. In another aspect, R¹, R² and R³ can be methyl groups and R⁴ can be a C₃-C₆ hydroxyalkylene group.

The cationic quaternary ammonium group can be 2-hydroxy-3-(trimethylammonium)propyl, 2-diethylaminoethyl, or 2,3-epoxypropyltrimethylammonium group, or a combination thereof.

The cationic group-modified starch can comprise a trimethyl ammonium group-modified starch.

The cationic group-modified starch can comprise a starch modified with a 2-diethylaminoethyl salt, a 2,3-epoxypropyltrimethylammonium salt, or a 2-hydroxy-3-(trimethylammonium)propyl salt, or a combination thereof.

The 2-diethylaminoethyl salt can comprise 2-diethylaminoethyl halide, the 2,3-epoxypropyltrimethylammonium salt can comprise 2,3-epoxypropyltrimethylammonium halide, and the 2-hydroxy-3-(trimethylammonium)propyl salt can comprise 2-hydroxy-3-(trimethylammonium)propyl halide.

The 2-diethylaminoethyl salt can comprise 2-diethylaminoethyl chloride, the 2,3-epoxypropyltrimethylammonium salt can comprise 2,3-epoxypropyltrimethylammonium chloride, and the 2-hydroxy-3-(trimethylammonium)propyl salt can comprise 2-hydroxy-3-(trimethylammonium)propyl chloride.

The starch further can comprise an unmodified starch and/or a non-ionic group-modified starch having a level of modification of about 1 to about 5 wt. %.

### Salts

The water-soluble films of the disclosure include a salt. The salt can comprise a metal cation. The salt can comprise a monovalent metal cation. The salt can comprise a multivalent metal cation. The salt can comprise a divalent metal cation. The salt can comprise a trivalent metal cation. The salt can comprise a cation selected from the group consisting of lithium, sodium, potassium, calcium, magnesium, manganese, barium, iron, and aluminum. The salt can be selected from calcium salts, magnesium salts, manganese salts, barium salts, iron salts, and mixtures thereof. The salt can be selected from calcium salts, magnesium salts, manganese salts, and mixtures thereof. The salt can comprise a calcium salt. The salt can comprise a magnesium salt. The salt can comprise a manganese salt.

The salt can comprise a non-metal cation. The salt can comprise an ammonium cation. The salt can comprise a substituted ammonium cation.

The salt can comprise an organic cation. Suitable organic cations include, but are not limited to, guanidinium. The salt can comprise an inorganic, non-metal cation. Suitable inorganic, non-metal cations include, but are not limited to, ammonium.

The salt can comprise an inorganic anion. Without intending to be bound by theory, it is believed that incorporating a salt comprising an inorganic anion into a water-soluble film can increase the film's capacity to retain water, effectively plasticizing the film. When present, the inorganic anion can be selected from a halide, a nitrate, a sulfate, a phosphate, and a combination thereof. The inorganic anion can be a halide. The halide can be selected from chloride, fluoride, bromide, iodide, or a combination thereof. The inorganic anion can be selected from chloride and fluoride. The salt can comprise calcium chloride.

The water-soluble film can comprise a multivalent salt comprising an inorganic anion and a multivalent salt comprising an organic anion. Suitable organic anions include, but are not limited to, acetate, citrate, gluconate, lactate, and mixtures thereof. Without intending to be bound by theory, it is believed that salts comprising organic anions are generally less effective at retaining water compared to salts comprising inorganic anions and accordingly provide less plasticization to the film; however, it is further believed that a multivalent salt comprising an organic anion can be an additional source of multivalent cation, thus contributing to the reduction of crystallinity imparted by the multivalent salt comprising the inorganic anion.

In general, the amount of salt included in a film, solution, or mixture containing a polyvinyl alcohol resin and a starch can be an amount in a range up to and including an amount necessary to fully compatibilize the polyvinyl alcohol resin and the starch, as defined herein. The amount of salt included in a film, solution, or mixture containing a polyvinyl alcohol resin and a starch need not fully compatibilize the polyvinyl alcohol resin and the starch. The amount of salt can be an amount sufficient to improve the compatibility of the polyvinyl alcohol in the starch relative to the compatibility of the polyvinyl alcohol resin and the starch in the absence of the salt, as determined according to the Compatibility Test Method.

The amount of salt in the film can be at least about 1 phr, or at least about 2 phr, about 3 phr, about 4 phr, about 5 phr, about 10 phr, about 15 phr, about 20 phr, about 25 phr, about 30 phr, or within a range formed by any such values as endpoints.

The salt can be provided in an amount sufficient to decrease the disintegration time of the film by at least about 5%, or at least about 10%, or at least about 20%, or at least about 30%, or at least about 40%, or at least about 50%. Without intending to be bound by theory, it is believed that incorporating a salt comprising an inorganic anion into a water-soluble film increases the film's capacity to retain water and making the film more readily disintegrable in water.

An amount of added salt that is sufficient to improve compatibility of a polyvinyl alcohol resin and a starch in an aqueous mixture can also be sufficient to affect mechanical properties of a film comprising the polyvinyl alcohol resin and the starch. In particular, added salt can reduce the tensile strength of a film, or increase the elasticity of a film. Without intending to be bound by theory, it is believed that adding certain salts (for instance, salts comprising ions that are generally characterized as “chaotropic” for their capacity to disrupt the hydrogen bonding structure of water, such as Ca²⁺ or Mg²⁺) to a PVOH/starch-containing film can increase the film's capacity to uptake and retain water and that the additional water can effectively plasticize the film. These effects resulting from the addition of salt can be countered, for instance, by making other compositional changes to the film, such as reducing the amount of plasticizer in the film.

The water-soluble film can comprise a multivalent salt and a monovalent metal salt. The monovalent metal salt can comprise a monovalent cation selected from the group of lithium, sodium, potassium, and a combination thereof. The monovalent cation can be lithium. The monovalent metal salt can comprise any inorganic or organic anions disclosed herein.

### Secondary Ingredients

The water-soluble film including the resin disclosed herein can contain other auxiliary agents and processing agents, such as, but not limited to, plasticizers, plasticizer compatibilizers, surfactants, lubricants, release agents, fillers, extenders, cross-linking agents, antiblocking agents, antioxidants, detackifying agents, antifoams, nanoparticles such as layered silicate-type nanoclays (e.g., sodium montmorillonite), bleaching agents (e.g., sodium metabisulfite, sodium bisulfite or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), and other functional ingredients, in amounts suitable for their intended purposes. Films including plasticizers are particularly contemplated. The water-soluble film can include a surfactant, an antioxidant, a bittering agent, a soil release polymer, an anti-redeposition aid, a chelant, a builder, a perfume, or combinations thereof. The amount of auxiliary agents can be, for example, up to about 50 wt. %, 20 wt. %, 15 wt. %, 10 wt. %, 5 wt. %, 4 wt. % and/or at least 0.01 wt. %, 0.1 wt. %, 1 wt. %, or 5 wt. %, individually or collectively.

### Plasticizers

A plasticizer is a liquid, solid, or semi-solid that is added to a material (usually a resin or elastomer) making that material softer, more flexible (by decreasing the glass transition temperature of the polymer), and easier to process. At low plasticizer levels, films may become brittle, difficult to process, or prone to breaking. At elevated plasticizer levels, films may be too soft, weak, or difficult to process for a desired use. Water is recognized as a very efficient plasticizer for PVOH and other polymers; including but not limited to water-soluble polymers, however, the volatility of water limits its utility, as polymer films need to have at least some resistance (robustness) to a variety of ambient conditions including low and high relative humidity. Accordingly, as used herein, the term “plasticizer” does not encompass water.

In general, for a water-soluble film of the disclosure that includes a salt, the water-soluble film can further include a plasticizer. The plasticizer can include, but is not limited to, a polyol, a sugar alcohol, a polyether, an amine, or a mixture thereof. For instance, the plasticizer can comprise a plasticizer selected from the group of a polyol, a sugar alcohol, a polyether, an amine, or a combination thereof. The plasticizer can include, but is not limited to, glycerol, diglycerin, ethylene glycol, diethylene glycol, triethyleneglycol, tetraethylene glycol, polyethylene glycols up to 400 MW, neopentyl glycol, 1,2-propylene glycol, 1,3-propanediol, dipropylene glycol, polypropylene glycol, 2-methyl-1,3-propanediol, trimethylolpropane, polyether polyols, isomalt, maltitol, sorbitol, xylitol, erythritol, adonitol, dulcitol, pentaerythritol, mannitol, ethanolamines, and mixtures thereof. The plasticizer does not include a divalent metal.

The total amount of the non-water plasticizer can be in a range of about 10 to about 50 weight parts per one hundred parts PVOH resin (PHR), or about 10 to about 45 PHR, or about 15 to about 45 PHR, or about 15 to 40 PHR, or about 20 to about 40 PHR, or about 25 to about 40 PHR, or about 25 to about 35 PHR, or about 25 PHR to about 30 PHR.

In some embodiments, the water-soluble film of the disclosure can be substantially free of the non-water plasticizers (i.e., polyol, sugar alcohol, polyether, or amine plasticizers) described above. A water-soluble film is substantially free of a component when the film includes less than about 5 PHR, less than about 4 PHR, less than about 3 PHR, less than about 2 PHR, or less than about 1 PHR of the component.

### Surfactants

Surfactants for use in water-soluble films are well known in the art. Optionally, surfactants are included to aid in the dispersion of the resin solution upon casting to form a film. Suitable surfactants can include the nonionic, cationic, anionic and zwitterionic classes. Suitable surfactants include, but are not limited to, propylene glycols, diethylene glycols, monoethanolamine, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), alkali metal salts of higher fatty acids containing about 8 to 24 carbon atoms, alkyl sulfates, alkyl polyethoxylate sulfates and alkylbenzene sulfonates (anionics), and amine oxides, N-alkylbetaines and sulfobetaines (zwitterionics). Other suitable surfactants include dialkyl sulfosuccinates, lactylated fatty acid esters of glycerin and propylene glycol, lactylic esters of fatty acids, sodium alkyl sulfates, polysorbate 20, polysorbate 60, polysorbate 65, polysorbate 80, alkyl polyethylene glycol, lecithin, acetylated fatty acid esters of glycerin and propylene glycol, sodium lauryl sulfate, acetylated esters of fatty acids, myristyl dimethylamine oxide, trimethyl tallow alkyl ammonium chloride, quaternary ammonium compounds, salts thereof and combinations of any of the foregoing. The surfactant can comprise a surfactant selected from the group consisting of polyoxyethylenated polyoxypropylene glycols, alcohol ethoxylates, alkylphenol ethoxylates, tertiary acetylenic glycols and alkanolamides, polyoxyethylenated amines, quaternary ammonium salts and quaternized polyoxyethylenated amines, and amine oxides, N-alkylbetaines, sulfobetaines, and combinations thereof.

The amount of surfactant in the water-soluble film can be in a range of about 0.1 wt. % to about 8.0 wt. %, or about 1.0 wt % to about 7.0 wt. %, or about 3 wt. % to about 7 wt. %, or about 5 wt. % to about 7 wt. %, or about 0.1 wt. % to 2.5 wt. %. Too little surfactant can sometimes result in a cast film having holes, whereas too much surfactant can result in the film having a greasy or oily feel from excess surfactant present on the surface of the film.

In some embodiments, the water-soluble film of the disclosure can be substantially free of the surfactants described above.

### Lubricants/Release Agents

Suitable lubricants/release agents for use in the water-soluble films described herein can include, but are not limited to, fatty acids and their salts, fatty alcohols, fatty esters, fatty amines, fatty amine acetates and fatty amides. Preferred lubricants/release agents are fatty acids, fatty acid salts, and fatty amine acetates. The amount of lubricant/release agent in the water-soluble film can be in a range of about 0.02 wt. % to about 1.5 wt. %, optionally about 0.1 wt. % to about 1 wt. %.

### Defoamer

The water-soluble films disclosed herein can also include a defoamer. Defoamers can aid in coalescing of foam bubbles. Suitable defoamers for use in water-soluble films according to the present disclosure include, but are not limited to, hydrophobic silicas, for example silicon dioxide, siloxane, silicone ethers, or fumed silica in fine particle sizes, and proprietary, non-mineral oil defoamers including Foam Blast® defoamers available from Emerald Performance Materials, including Foam Blast®327, Foam Blast® UVD, Foam Blast®163, Foam Blast®269, Foam Blast®338, Foam Blast®290, Foam Blast®332, Foam Blast®349, Foam Blast®550 and Foam Blast®339. For instance, defoamers can be used in an amount of 0.5 PHR, or less, for example, 0.05 PHR, 0.04 PHR, 0.03 PHR, 0.02 PHR, or 0.01 PHR.

### Antioxidants

The water-soluble film disclosed herein can further include an antioxidant, for example, as a chloride scavenger. For example, suitable antioxidants/chloride scavengers include sulfite, bisulfite, thiosulfate, thiosulfate, iodide, nitrite, carbamate, ascorbate, and combinations thereof. The antioxidant can comprise propyl gallate (PGA), citric acid (CA), sodium metabisulfite (SMBS), carbamate, ascorbate, or a combination thereof. The antioxidant can be included in the film in an amount in a range of about 0.25 to about 1.5 PHR, for example, about 0.25 PHR, about 0.30 PHR, about 0.35 PHR, about 0.40 PHR, about 0.45 PHR, about 0.5 PHR, about 0.75 PHR, about 1.0 PHR, about 1.25 PHR, or about 1.5 PHR.

### Fillers

Fillers can be included in the water-soluble films and can include bulking agents, extenders, antiblocking agents, detackifying agents and combinations thereof. Suitable fillers for use in the water-soluble films disclosed herein include, but are not limited to, starches, modified starches, crosslinked polyvinylpyrrolidone, crosslinked cellulose, microcrystalline cellulose, silica, metallic oxides, calcium carbonate, talc, mica, stearic acid, and metal salts thereof, for example, magnesium stearate. The amount of filler/extender/antiblocking agent/detackifying agent in the water-soluble film can be in a range of about 1 wt. % to about 6 wt. %, or about 1 wt. % to about 4 wt. %, or about 2 wt. % to about 4 wt. %, or about 1 PHR to about 6 PHR, or about 1 PHR to about 4 PHR, or about 2 PHR to about 4 PHR, for example.

The water-soluble film can include 2 or more PHR (e.g., 2 PHR to 6 PHR or 2 PHR to 4 PHR) of a filler. For instance, the film can include 2 or more PHR (e.g., 2 PHR to 6 PHR or 2 PHR to 4 PHR) of a filler and the filler can comprise a bulking agent, an antiblocking agent, or a combination thereof. Without intending to be bound by theory, it is believed that the inclusion of 2 or more PHR (e.g., 2 PHR to 6 PHR or 2 PHR to 4 PHR) of a filler can be useful to prevent weeping or migration of plasticizer out of the film, when the plasticizer is included in an amount of greater than or equal to 30 PHR, for example, in a range of 30 PHR to 50 PHR.

An anti-block agent can be present in the film in an amount of at least 0.1 PHR, or at least 0.5 PHR, or at least 1 PHR, or in a range of about 0.1 to 5.0 PHR, or about 0.1 to about 3.0 PHR, or about 0.4 to 1.0 PHR, or about 0.5 to about 0.9 PHR, or about 0.5 to about 2 PHR, or about 0.5 to about 1.5 PHR, or 0.1 to 1.2 PHR, or 0.1 to 2.7 PHR, for example 0.5 PHR, 0.6 PHR, 0.7 PHR, 0.8 PHR, or 0.9 PHR. Suitable anti-block agents can include, but are not limited to SiO₂, stearic acid, and certain starches. Use of a starch as an anti-block agent or friction-reducing agent is described in U.S. Patent Application Publication No. 2018/0118906A1, which is hereby incorporated by reference in its entirety. In embodiments wherein a starch is present in the film as an anti-block agent or friction-reducing agent, the amount of starch present in the film as an anti-block agent or friction-reducing agent should be considered to be in addition to the amount of starch for which a compatibility ratio with the polyvinyl alcohol comprising the film is measured.

A suitable median particle size for the anti-block agent includes a median size in a range of about 3 or about 4 microns to about 11 microns, or about 4 to about 8 microns, or about 5 to about 6 microns, for example 5, 6, 7, 8, or 9 microns.

### Aversive Agents

Aversive agents may be incorporated within the water-soluble film or may be applied as a coating to the water-soluble film. An aversive compound such as a bitterant or a pungent may be added as a deterrent to ingestion of the film by a child or animal. The bitterant adds a bitter taste to the composition to which it is added. Suitable bitterants include denatonium salts (e.g., denatonium benzoate, denatonium saccharide, denatonium chloride), sucrose octaacetate, quinine, flavonoids (e.g., quercetin, naringen), and quassinoids (e.g., quassin, brucine). The pungent adds a sharp biting taste when ingested and a burning sensation when topically applied to the skin. Suitable pungents include capsaicin, piperine, allyl isothiocyanate, and resinferatoxin. Suitable levels of incorporation vary according to the particular bitterant or pungent material. As understood by the skilled artisan, the aversive component should be incorporated as a level sufficiently high to impart the unpleasant taste or sensation, yet sufficiently low to avoid potential toxicity from the aversive itself. The aversive agent may be diluted from commercial form or otherwise mixed with a solvent for ease in mixing with other water-soluble film components or applying as a coating to the water-soluble film. Such solvents may be selected from water, lower molecular weight alcohols (methanol, ethanol, etc.) or plasticizers disclosed herein.

### Methods of Making Films

The water-soluble films including the water-soluble resins disclosed herein can be made by any suitable method. Processes for making water-soluble films and pouches include solvent casting, blow-molding, extrusion and blown extrusion, as known in the art. Solvent casting processes for making polyvinyl alcohol-containing films are well-known in the art. For example, in the film-forming process, the polyvinyl alcohol resin(s), optionally other film-forming resins, and secondary additives can be dissolved in a solvent, typically water, metered onto a surface, allowed to substantially dry (or force-dried) to form a cast film, and then the resulting cast film is removed from the casting surface. The process can be performed batchwise, and is more efficiently performed in a continuous process.

In the formation of continuous films comprising polyvinyl alcohol, it is conventional practice to meter a solution or mixture comprising polyvinyl alcohol onto a moving casting surface, for example, a continuously moving metal drum or belt, causing the solvent to be substantially removed from the liquid, whereby a self-supporting cast film is formed, and then stripping the resulting cast film from the casting surface. The solution or mixture can optionally be metered or coated onto a carrier film, release liner, or removable backing, whereby after solvent removal, the resulting cast film or coating can be separated from the carrier film, release liner, or removable backing (for example, immediately upon drying or at a later point in time, e.g., prior to use) or remain attached to the carrier film, release liner, or removable backing.

A film according to the disclosure herein can be produced by solvent casting, e.g., using a solvent band casting system. The system can include a tank for mixing and/or storing a polymer solution or mixture, having optional secondary additives, for use with a band casting machine having at least a first and a second rotating drums about which a continuous band (e.g., metal band) is tensioned to travel with the rotation of the drums. A sheeting die can apply the polymer solution or mixture from the tank to the metal band where a drying chamber, enclosing at least a portion of the metal band downline of the sheeting die, is used to remove solvent from the polymer solution or mixture as it travels in a thin sheet on the metal band. In addition, a release coating can be used to provide one or more advantages to the film and/or the process. For example, the release coating can substantially reduce or eliminate bubbles in the produced polymer film, or the release coating can improve the ease of release of the produced film from the casting surface. A roll coater release coating applicator in communication with a supply of a release coating and a portion of the band can transfer fluid release coating to the casting surface prior to application of the polymer solution or mixture to the band. A suitable solvent band casting system and related materials are further described in U.S. Patent Application Publication Nos. 2006/0081176 A1 and 2007/0085234 A1, the disclosures of which are incorporated herein by reference in their entireties.

In general, the casting surface can be any suitable substrate for producing polymeric films to one of skill in the art. The substrate can be a casting roller or drum, a casting belt, or a combination thereof. As used herein, the substrate is used for producing a polymer film from a polymer resin or polymer resin solution or mixture. The substrate comprises a substrate surface and the substrate surface is coated with a release coating. The polymer resin solution or mixture can be cast onto a substrate while the substrate is moving, e.g., rotating. The substrate can be a casting drum. The substrate can be a casting belt. The substrate can comprise stainless steel, and optionally can have a stainless steel surface. The substrate can comprise stainless steel that is optionally plated, e.g., chrome plated, nickel plated, zinc plated or a combination thereof.

Optionally, the water-soluble film can be a free-standing film consisting of one layer or a plurality of like layers.

### PVOH/Starch Films

A water-soluble film according to the disclosure containing a polyvinyl alcohol resin and a starch can be made, for example, by solution casting of an aqueous solution or mixture comprising the polyvinyl alcohol resin and the starch. It is generally desirable to prepare the aqueous solution or mixture under conditions sufficient to provide a mostly or completely homogeneous solution or mixture. For instance, heating a starch-containing mixture can promote gelatinization and dissolution of the starch. In general, conditions including, but not limited to, temperature, mixing time, shear, or any combination thereof can be adjusted to provide a mostly or completely homogeneous solution or mixture.

Mixing an aqueous solution or mixture can entrain air. Solution casting of a solution or mixture that contains entrained air can result in bubble formation in a cast film, which may be undesirable. A solution casting process can include, prior to casting, a step of degassing the aqueous solution or mixture, to allow or accelerate dissipation of entrained air from the solution or mixture and reduce or eliminate bubble formation in the cast film. The degassing step can include heating the solution or mixture, for instance at about 90° C. for at least 12 hours, optionally under reduced pressure.

The solids content of the aqueous solution or mixture is not particularly limited. For solution casting of a film according to the disclosure, the aqueous solution or mixture can have a solids content (i.e., non-water content) of about 10% by weight of the aqueous solution or mixture, or about 15%, 20%, 25%, 30%, 35%, 40%, 45%, or 50%, or within a range formed by any such values as endpoints. As the solids content decreases, the compatibility of the polyvinyl alcohol and the starch generally increases, as more polyvinyl alcohol and starch can be dissolved in the water. However, as the amount of water increases, the time and energy required for drying the film generally increases. Thus, while the solids content can be less than about 10% to improve compatibility and solubility, such concentrations are impractical when scaled up to a commercial process due to the time and energy costs.

The ratio of the amounts of polyvinyl alcohol resin and starch in a film or aqueous solution or mixture comprising polyvinyl alcohol resin and starch is not particularly limited. For instance, the ratio of the amounts of polyvinyl alcohol resin to starch can be in a range of about 99:1 to about 1:99, or about 95:5 to about 5:95, or about 90:10 to about 10:90, or about 80:20 to about 20:80, or about 70:30 to about 30:70, or about 60:40 to about 40:60. The compatibility of a polyvinyl alcohol resin and a starch in an aqueous solution or mixture can be affected by the ratio of the amounts of the polyvinyl alcohol resin to the starch. In general, without intending to be bound by theory, it is believed that in compositions where one of the starch or polyvinyl alcohol accounts for substantially all of the forming material (e.g., compositions having at least 90% polyvinyl alcohol (i.e., no greater than 10% starch) or at least 90% starch (i.e., no greater than 10% polyvinyl alcohol) the starch and polyvinyl alcohol will demonstrate good or complete compatibility, for any combination of starch and polyvinyl alcohol. However, without intending to be bound by theory, it is believed that non-compatibility between a starch and a polyvinyl alcohol will become apparent as the amount of the minor film forming material (i.e., starch or polyvinyl alcohol) increases and the relative amounts approach a 50/50 split.

While not intended to be limiting, preparing an aqueous solution or mixture for making a film according to the disclosure by solution casting can include: adding a starch to an aqueous solution containing salt and optionally one or more secondary ingredients; heating the resulting mixture with mixing, for instance at a temperature in a range of 65-80° C., for a time sufficient to substantially gelatinize or dissolve the starch; adding a polyvinyl alcohol resin and mixing while maintaining a temperature in a range of 65-80° C. for a time sufficient to dissolve the polyvinyl alcohol copolymer; and optionally degassing the resulting solution or mixture.

### Water-Soluble Articles

The film is useful for creating an article and/or pouch to contain a composition, for example, a cleaning composition. The composition contained in the pouch may take any form such as powders, gels, pastes, liquids, tablets, or any combination thereof. The film is also useful for any other application in which improved wet handling and low cold water residues are desired. The film forms at least one side wall of the article and/or pouch, optionally the entire article and/or pouch, and preferably an outer surface of the at least one sidewall.

The film described herein can also be used to make an article and/or pouch with two or more compartments made of the same film or in combination with films of other polymeric materials. Additional films can, for example, be obtained by casting, blow-molding, extrusion or blown extrusion of the same or a different polymeric material, as known in the art. The polymers, copolymers or derivatives thereof suitable for use as the additional film can comprise polyvinyl alcohols, polyvinyl pyrrolidone, polyalkylene oxides, polyacrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthan, and carrageenans. For example, polymers can be selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and combinations thereof, or selected from polyvinyl alcohols, polyvinyl alcohol copolymers and hydroxypropyl methyl cellulose (HPMC), and combinations thereof. For example, the level of polymer in the packet material, for example the PVOH copolymer described above, as described above, can be at least 60%.

The articles and/or pouches of the present disclosure can include at least one sealed compartment. Thus, the articles and/or pouches may comprise a single compartment or multiple compartments. A water-soluble pouch or sachet can be formed from two layers of water-soluble polymer film sealed at an interface, or by a single film that is folded upon itself and sealed. One or both of the films can include the PVOH film described above. The films define an interior article and/or pouch container volume which contains any desired composition for release into an aqueous environment.

The pouch container volume is not particularly limited. The pouch container volume can be, for example, 25 mL or less. The pouch container volume can be less than 25 mL. The pouch container volume can be less than 50 mL.

The composition for use in the pouch is not particularly limited. For pouches comprising multiple compartments, each compartment may contain identical and/or different compositions, including but not limited to automatic dishwashing (ADW) compositions. In turn, the compositions may take any suitable form including, but not limited to liquid, solid and combinations thereof (e.g., a solid suspended in a liquid). The pouches can comprise a first, second, and third compartment, each of which respectively contains a different first, second, and third composition. Liquid detergents are particularly contemplated.

The compartments of multi-compartment articles and/or pouches may be of the same or different size(s) and/or volume(s). The compartments of the present multi-compartment articles and/or pouches can be separate or conjoined in any suitable manner. The second and/or third and/or subsequent compartments can be superimposed on the first compartment. The third compartment can be superimposed on the second compartment, which is in turn superimposed on the first compartment in a sandwich configuration. Alternatively, the second and third compartments may be superimposed on the first compartment. However, it is also equally envisaged that the first, second and optionally third and subsequent compartments may be attached to one another in a side by side relationship. The compartments may be packed in a string, each compartment being individually separable by a perforation line. Hence each compartment may be individually torn-off from the remainder of the string by the end-user, for example, so as to pre-treat or post-treat a fabric with a composition from a compartment. The first compartment can be surrounded by at least the second compartment, for example in a tire-and-rim configuration, or in a pouch-in-a-pouch configuration.

The articles and/or pouches of the present disclosure may comprise one or more different films. For example, for single compartment packets, the packet may be made from one wall that is folded onto itself and sealed at the edges, or alternatively, two walls that are sealed together at the edges. For multiple compartment packets, the article and/or packet may be made from one or more films such that any given packet compartment may comprise walls made from a single film or multiple films having differing compositions. A multi-compartment article and/or pouch can comprise at least three walls: an outer upper wall; an outer lower wall; and a partitioning wall. The outer upper wall and the outer lower wall are generally opposing and form the exterior of the article and/or pouch. The partitioning wall is interior to the article and/or pouch and is secured to the generally opposing outer walls along a seal line. The partitioning wall separates the interior of the multi-compartment article and/or pouch into at least a first compartment and a second compartment.

The single compartment or plurality of sealed compartments can contain a composition. The plurality of compartments may each contain the same or a different composition. The composition is selected from a liquid, solid or combination thereof.

The disclosure provides a unit dose article comprising at least one compartment and optionally a composition housed in the compartment, wherein at least one wall of the compartment comprises a water-soluble film of the disclosure.

Article and/or Pouch Contents

In general, the water-soluble articles of the disclosure can contain a household care product, a personal care product, or a non-household care product. The unit dose articles can include a composition housed in the compartment and the composition can comprise an oxidizing agent. The oxidizing agent can comprise a hypochlorite salt, a chloramine, a chlorinated isocyanurate, a brominated isocyanurate, a chlorate, a bromate, a perchlorate, a perbromate, calcium hydroxide, calcium chloride, a percarbonate, a perborate, a periodate, a persulfate, a permanganate, a chromate, a dichromate, a nitrate, a nitrite, a peroxide, a ketone peroxide, a peroxy acid, an inorganic acid, or a combination thereof. The oxidizing agent can comprise a hypochlorite salt, a chloramine, a chlorinated isocyanurate, calcium hydroxide, calcium chloride, a percarbonate, a perborate, a persulfate, a permanganate, a peroxide, a peroxy acid, or a combination thereof.

### Methods of Making Articles

Articles, such as pouches or packets, may be made using any suitable equipment and method. For example, single compartment pouches may be made using vertical form filling, horizontal form filling, or rotary drum filling techniques commonly known in the art. Such processes may be either continuous or intermittent. The film may be dampened, and/or heated to increase the malleability thereof. The method may also involve the use of a vacuum to draw the film into a suitable mold. The vacuum drawing the film into the mold can be applied for about 0.2 to about 5 seconds, or about 0.3 to about 3, or about 0.5 to about 1.5 seconds, once the film is on the horizontal portion of the surface. This vacuum can be such that it provides an under-pressure in a range of 10 mbar to 1000 mbar, or in a range of 100 mbar to 600 mbar, for example.

The molds in which packets may be made can have any shape, length, width, and depth, depending on the required dimensions of the pouches. The molds may also vary in size and shape from one to another, if desirable. For example, the volume of the final pouches may be about 5 mL to about 300 mL, or about 10 mL to 150 mL, or about 20 mL to about 100 mL, and the mold sizes may be adjusted accordingly.

### Thermoforming

A thermoformable film is one that can be shaped through the application of heat and a force. Thermoforming a film is the process of heating the film, shaping it (e.g., in a mold), and then allowing the film to cool, whereupon the film will hold its shape, e.g., the shape of the mold. The heat may be applied using any suitable means. For example, the film may be heated directly by passing it under a heating element or through hot air, prior to feeding it onto a surface or once on a surface. Alternatively, it may be heated indirectly, for example by heating the surface or applying a hot item onto the film. The film can be heated using an infrared light. The film may be heated to a temperature in a range of about 50° C. to about 150° C., about 50° C. to about 120° C., about 60° C. to about 130° C., about 70° C. to about 120° C., or about 60° C. to about 90° C. The film may be heated to a temperature in a range of about 30° C. to about 100° C., or about 40° C. to about 100° C., or about 50° C. to about 100° C., or about 60° C. to about 100° C., or about 30° C. to about 90° C., or about 40° C. to about 90° C., or about 50° C. to about 90° C. The film may be heated to temperature in a range of about 30° C. to about 80° C., or about 40° C. to about 80° C., or about 50° C. to about 80° C., or about 60° C. to about 80° C., or about 30° C. to about 70° C., or about 30° C. to about 60° C., or about 30° C. to about 50° C. Thermoforming can be performed by any one or more of the following processes: the manual draping of a thermally softened film over a mold, or the pressure induced shaping of a softened film to a mold (e.g., vacuum forming), or the automatic high-speed indexing of a freshly extruded sheet having an accurately known temperature into a forming and trimming station, or the automatic placement, plug and/or pneumatic stretching and pressuring forming of a film.

Alternatively, the film can be wetted by any suitable means, for example directly by spraying a wetting agent (including water, a solution of the film composition, a plasticizer for the film composition, or any combination of the foregoing) onto the film, prior to feeding it onto the surface or once on the surface, or indirectly by wetting the surface or by applying a wet item onto the film.

Once a film has been heated and/or wetted, it may be drawn into an appropriate mold, preferably using a vacuum. The filling of the molded film can be accomplished by utilizing any suitable means. The most preferred method will depend on the product form and required speed of filling. The molded film can be filled by in-line filling techniques. The filled, open packets can then be closed forming the pouches, using a second film, by any suitable method. This may be accomplished while in horizontal position and in continuous, constant motion. The closing may be accomplished by continuously feeding a second film, preferably water-soluble film, over and onto the open packets and then preferably sealing the first and second film together, typically in the area between the molds and thus between the packets.

### Sealing of Water-Soluble Articles

Any suitable method of sealing the packet and/or the individual compartments thereof may be utilized. Non-limiting examples of such means include heat sealing, solvent welding, solvent or wet sealing, and combinations thereof. Typically, only the area which is to form the seal is treated with heat or solvent. The heat or solvent can be applied by any method, typically on the closing material, and typically only on the areas which are to form the seal. If solvent or wet sealing or welding is used, it may be preferred that heat is also applied. Preferred wet or solvent sealing/welding methods include selectively applying solvent onto the area between the molds, or on the closing material, by for example, spraying or printing this onto these areas, and then applying pressure onto these areas, to form the seal. Alternatively, solvent can be non-selectively applied to the closing material, for instance to an entire surface of the closing material, followed by sealing by applying pressure to the area between the molds. Sealing rolls and belts (optionally also providing heat) can be used, for example.

An inner film can be sealed to outer film(s) by solvent sealing. The sealing solution is generally an aqueous solution. The sealing solution can comprise water. The sealing solution can comprise water and can further include one or more diols and/or glycols such as 1,2-ethanediol (ethylene glycol), 1,3-propanediol, 1,2-propanediol, 1,4-butanediol (tetramethylene glycol), 1,5-pantanediol (pentamethylene glycol), 1,6-hexanediol (hexamethylene glycol), 2,3-butanediol, 1,3-butanediol, 2-methyl-1,3-propanediol, various polyethylene glycols (e.g., diethylene glycol, triethylene glycol), and combinations thereof. The sealing solution can comprise erythritol, threitol, arabitol, xylitol, ribitol, mannitol, sorbitol, galactitol, fucitol, iditol, inositol, volemitol, isomalt, maltitol, lactitol.

The sealing solution can be applied to the interfacial areas of the inner film in any amount suitable to adhere the inner and outer films. As used herein, the term “coat weight” refers to the amount of sealing solution applied to the film in grams of solution per square meter of film. In general, when the coat weight of the sealing solvent is too low, the films do not adequately adhere and the risk of pouch failure at the seams increases. Further, when the coat weight of the sealing solvent is too high, the risk of the solvent migrating from the interfacial areas increases, increasing the likelihood that etch holes may form in the sides of the pouches. The coat weight window refers to the range of coat weights that can be applied to a given film while maintaining both good adhesion and avoiding the formation of etch holes. A broad coat weight window is desirable as a broader window provides robust sealing under a broad range of operations. Suitable coat weight windows are at least about 3 g/m², or at least about 4 g/m², or at least about 5 g/m², or at least about 6 g/m².

### PVOH/Starch Compatibility

Polyvinyl alcohol resins and starches can exhibit low compatibility with each other. Polyvinyl alcohol homopolymers, in particular, can exhibit low compatibility with starches. Low compatibility between a polyvinyl alcohol resin and a starch can be indicated, for instance, by phase separation in an aqueous mixture containing the polyvinyl alcohol resin and the starch. Low compatibility between a polyvinyl alcohol resin and a starch can hinder producing a homogeneous film comprising the polyvinyl alcohol and the starch. Solution casting of a phase-separated aqueous mixture containing a polyvinyl alcohol resin and a starch (for instance, an aqueous mixture having a PVOH-rich aqueous phase and a starch-rich aqueous phase) onto a casting surface can lead to a solution layer having PVOH-rich and starch-rich domains, which upon drying can form a non-homogeneous film. Furthermore, phase separation between a polyvinyl alcohol resin and a starch that occurs within a solution-cast layer, before the layer has fully dried, can introduce PVOH-rich and/or starch-rich domains into the resulting solution cast film.

The compatibility ratio between a polyvinyl alcohol resin and a starch in an aqueous solution or mixture, as determined according to the Compatibility Test Method described herein, can be less than about 40%, or less than about 35%, or less than about 30%, or less than about 25%, or less than about 20%, or less than about 15%, or less than about 10%. In general, if the compatibility ratio is less than about 10%, then the aqueous solution or mixture can be useful for making a film by solution casting. If the compatibility ratio is greater than about 10%, then it can be desirable to improve the compatibility of the polyvinyl alcohol resin and the starch in order to make a film by solution casting.

Approaches to attempting to improve the compatibility between a polyvinyl alcohol resin and a starch in an aqueous solution or mixture can include diluting the aqueous solution or mixture and/or adjusting the levels of secondary ingredients (e.g., plasticizer(s), surfactant(s)). However, these approaches are not without disadvantages. Diluting the aqueous solution or mixture can increase film manufacturing costs and/or decrease throughput due to energy and time requirements for removing additional water. Adjusting the levels of secondary ingredients may undesirably affect properties of the resulting film.

### Salt Addition

Inorganic and organic ions can be classified according to the Hofmeister series (or lyotropic series), which is a classification of ions based on capacity to affect the solubility of dissolved species. In general, ions that increase the degree of order and structure of water, such as by enhancing hydrogen bonding, are characterized as “kosmotropic,” and ions that decrease the degree of order and structure of water, such as by disrupting hydrogen bonding, are characterized as “chaotropic.” For an aqueous solution or mixture containing one or more dissolved polymers, addition of ions characterized as kosmotropic can compete with the dissolved polymers for water, reducing the amount of water available for interacting with the polymers and promoting intra-polymer interactions, reducing the aqueous solubility of the polymers (i.e., “salting out”). Conversely, addition of ions characterized as chaotropic can increase the aqueous solubility of polymers (i.e., “salting in”). A partial list of cations classified according to increasing level of chaotropy is NH₄⁺ (most kosmotropic), K⁺, Na⁺, Li⁺, Mg²⁺, Ca²⁺, guanidinium (most chaotropic).

As shown in examples that follow, addition of ions characterized as having a high degree of chaotropy (e.g., Mg²⁺ or guanidinium) to aqueous mixtures containing polyvinyl alcohol and starch increased the compatibility of the polyvinyl alcohol and the starch. Without intending to be bound by theory, it is believed that addition of ions characterized as having a high degree of chaotropy can improve the compatibility of a polyvinyl alcohol resin and a starch, for instance by increasing aqueous solubility of one or both polymers and/or by disrupting intramolecular hydrogen bonding and accordingly promoting interactions (such as hydrophobic or van der Waals interactions) between the polyvinyl alcohol resin and the starch. It is further believed that added salt can disrupt starch retrogradation, such that a dissolved starch, upon cooling, is less prone to forming crystalline structures that can have poor compatibility with polyvinyl alcohol resins.

### Test Methods

### Dissolution and Disintegration Test (MSTM 205)

A film can be characterized by or tested for Dissolution Time and Disintegration Time according to the MonoSol Test Method 205 (MSTM 205), a method known in the art. See, for example, U.S. Pat. No. 7,022,656. Apparatus and Materials:
600 mL Beaker
Magnetic Stirrer (Labline Model No. 1250 or equivalent)
Magnetic Stirring Rod (5 cm)
Thermometer (0 to 100° C.±1° C.)
Template, Stainless Steel (3.8 cm×3.2 cm)
Timer (0-300 seconds, accurate to the nearest second)
Polaroid 35 mm slide Mount (or equivalent)
MonoSol 35 mm Slide Mount Holder (or equivalent)
Distilled water

All films to be tested were conditioned for a minimum of 24 hours in a 23° C./35% relative humidity environment. For each film to be tested, three test specimens are cut from a film sample that is a 3.8 cm×3.2 cm specimen. If cut from a film web, specimens should be cut from areas of web evenly spaced along the traverse direction of the web. Each test specimen is then analyzed using the following procedure.

Lock each specimen in a separate 35 mm slide mount.

Fill beaker with 500 mL of distilled water. Measure water temperature with thermometer and, if necessary, heat or cool water to maintain temperature at about 5° C. (about 41° F.).

Mark height of column of water. Place magnetic stirrer on base of holder. Place beaker on magnetic stirrer, add magnetic stirring rod to beaker, turn on stirrer, and adjust stir speed until a vortex develops which is approximately one-fifth the height of the water column. Mark depth of vortex.

Secure the 35 mm slide mount in the alligator clamp of the 35 mm slide mount holder such that the long end of the slide mount is parallel to the water surface. The depth adjuster of the holder should be set so that when dropped, the end of the clamp will be 0.6 cm below the surface of the water. One of the short sides of the slide mount should be next to the side of the beaker with the other positioned directly over the center of the stirring rod such that the film surface is perpendicular to the flow of the water.

In one motion, drop the secured slide and clamp into the water and start the timer. Disintegration occurs when the film breaks apart. When all visible film is released from the slide mount, raise the slide out of the water while continuing to monitor the solution for undissolved film fragments. Dissolution occurs when all film fragments are no longer visible and the solution becomes clear.

The results should include the following: complete sample identification; individual and average disintegration and dissolution times; and water temperature at which the samples were tested.

Film disintegration times (1) and film dissolution times (S) can be corrected to a standard or reference film thickness using the exponential algorithms shown below in Equation 1 and Equation 2, respectively.

$${I}_{corrected} = {I}_{measured} \times {( reference thickness / measured thickness )}^{1.93} \qquad [ 1 ]$$

$${S}_{corrected} = {S}_{measured} \times {( reference thickness / measured thickness )}^{1.83} \qquad [ 2 ]$$

Films were also tested for disintegration and dissolution in salt water. For these experiments, the MSTM-205 method was carried out as described above, except that films were immersed in 500 mL of a solution of 3.5% sodium chloride in distilled water at 5° C., instead of 500 mL of distilled water at 5° C. Disintegration and dissolution times in salt water were determined using the same criteria used to determine disintegration and dissolution times in water.

### DSC Method (MSTM 122)

Tests are performed using a TA Instruments Q2000 differential scanning calorimeter (DSC) or equivalent with a 50 mL/min nitrogen purge and TZERO aluminum hermetic pans (available from TA Instruments) to avoid weight losses during temperature ramping. Film specimens to be tested are cut in small pieces to provide about 3-5 mg total sample that fits into the pans (e.g., about 3 stacked, cut film pieces). The DSC test is performed by equilibrating the sample at −80° C., followed by (1) heating the sample to 75° C. at a rate of 10° C./min to begin generating a first DSC heating curve, (2) maintaining the sample at 75° C. for 10 minutes, (3) heating the sample from 75° C. to 200° C. at a rate of 10° C./min to complete the first DSC heating curve, (4) cooling the sample to −75° C. at a rate of −5° C./min to generate a DSC cooling curve, and optionally (5) re-heating the sample to 200° C. at a rate of 10° C./min to generate a second DSC heating curve. Upon generating the curves, transitions attributable to glass transition, melting, and crystallization are assigned; glass transition temperature, melting temperature, and crystallization temperature (Tg, Tm, and Tc, respectively) are determined; and enthalpies of melting or crystallization are determined according to standard calorimetry analysis. Optionally, a second glass transition temperature (Tg₂) for the sample can be determined from the re-heating step (3), corresponding to a glass transition of the film after residual water has been driven off (i.e., during the first heating step).

### Tensile Strength Test

A water-soluble film characterized by or to be tested for tensile strength according to the Tensile Strength (TS) Test is analyzed as follows. The procedure includes the determination of tensile strength according to ASTM D 882 (“Standard Test Method for Tensile Properties of Thin Plastic Sheeting”) or equivalent. An INSTRON tensile testing apparatus (Model 5544 Tensile Tester or equivalent) is used for the collection of film data. A minimum of three test specimens, each cut with reliable cutting tools to ensure dimensional stability and reproducibility, are tested in the machine direction (MD) (where applicable) for each measurement. Films to be tested are conditioned for a minimum of 24 hours in a 23±2.0° C. and 35±5% relative humidity environment; tensile strength tests are also conducted in a 23±2.0° C. and 35±5% relative humidity environment. For tensile strength, 1″-wide (2.54 cm) samples of a single film sheet having a thickness of 76 μm are prepared. The sample is then transferred to the INSTRON tensile testing machine to proceed with testing while minimizing exposure in the 35% relative humidity environment. The tensile testing machine is prepared according to manufacturer instructions, equipped with a 500 N load cell, and calibrated. The correct grips and faces are fitted (INSTRON grips having model number 2702-032 faces, which are rubber coated and 25 mm wide, or equivalent). The samples are mounted into the tensile testing machine and analyzed to determine tensile strength (i.e., stress required to break film).

Young's modulus was determined as the slope of a linear fit of stress-strain data over the range of 1-3% strain.

### Elongation at Break Test

The procedure includes the determination of elongation at break based on ASTM D 882 (“Standard Test Method for Tensile Properties of Thin Plastic Sheeting”) or equivalent. An INSTRON® tensile testing apparatus (Model 5544 Tensile Tester or equivalent) is used for the collection of film data. A minimum of three test specimens, each cut with reliable cutting tools to ensure dimensional stability and reproducibility, are tested in the machine direction (MD) (where applicable) for each measurement. Films to be tested are conditioned for a minimum of 24 hours in a 23±2.0° C. and 35±5% relative humidity environment; elongation at break tests are also conducted in a 23±2.0° C. and 35±5% relative humidity environment. For elongation at break determination, 1″-wide (2.54 cm) samples of a single film sheet having a thickness of 1.4±0.15 mil (about 35.6±3.8 μm) are prepared. The sample is then transferred to the INSTRON® tensile testing machine to proceed with testing while minimizing exposure in the 35% relative humidity environment. The tensile testing machine is prepared according to manufacturer instructions, equipped with a 500 N load cell, and calibrated. The correct grips and faces are fitted (INSTRON® grips having model number 2702-032 faces, which are rubber coated and 25 mm wide, or equivalent). The samples are mounted into the tensile testing machine and analyzed to determine the elongation at break (i.e., where Young's Modulus applies).

### Compatibility Test

The compatibility of two polymers was assessed by measuring a degree of phase separation, if any, in an aqueous mixture containing the two polymers and optionally one or more additives. Samples for assessing compatibility of a polyvinyl alcohol resin and a starch, optionally in the presence of one or more additives, are prepared as follows. An aqueous solution optionally containing one or more additives is prepared by mixing the additives in water, and heating at a temperature up to 80° C. if necessary to dissolve the additives. With the solution at 80° C., starch is added, followed by mixing for 75 minutes at 80° C. Polyvinyl alcohol resin is then added, followed by mixing for 30 minutes at 80° C. The final aqueous mixture has 30 wt. % solids content (i.e., 30% non-water content). The aqueous mixture is transferred to a loosely covered 1-L HDPE jar with vertical sides and held for 16 hours at 90° C. to degas. If no visible separation of layers is present in the aqueous mixture following the 16-hour hold, the polyvinyl alcohol resin and starch are considered fully compatible. If two visibly distinct layers are present following the 16-hour hold, the compatibility ratio (expressed in %) of the polyvinyl alcohol resin and the starch is defined as the ratio SH/FH, where SH (in cm) is the vertical height in the jar of the layer having the lower volume and FH (in cm) is the vertical distance between the bottom of the jar and the air/sample interface. The layer having the lower volume can be the bottom layer or the top layer. The compatibility ratio can range from greater than 0% to 50%. In general, a lower compatibility ratio indicates a low degree of phase separation and, accordingly, high compatibility.

### EXAMPLES

### Example 1

Aqueous mixtures 1a-1c containing a blend of a PVOH polymer, a starch, plasticizers, secondary ingredients, and optionally magnesium chloride or guanidinium chloride were prepared according to the recipes in Table 1. Amounts of components are listed as parts per hundred parts of total resin content (i.e., PVOH+starch). Solids content (i.e., non-water content) of each mixture was 30 wt. % based on the total weight of the mixture. Preparation of the mixtures included mixing for 75 minutes at a temperature in a range of 65-80° C. following addition of the starch in order to promote gelatinization and dissolution of the starch. Compatibility ratios between the PVOH polymer and the starch for each mixture were evaluated according to the Compatibility Test Method.

TABLE 1

| | 1a | 1b | 1c | 1d |
|---|---|---|---|---|
| PVOH homopolymer | 59.0 phr | 59.0 phr | 59.0 phr | 59.0 phr |
| Hydroxyethyl-modified starch | 41.0 phr | 41.0 phr | 41.0 phr | 41.0 phr |
| Plasticizers | 32.0 phr | 29.7 phr | 29.7 phr | 29.7 phr |
| Secondary ingredients | 2.5 phr | 2.8 phr | 3.8 phr | 2.8 phr |
| Magnesium chloride | | 5.7 phr | 11.4 phr | |
| Guanidinium chloride | | | | 5.7 phr |
| Compatibility ratio | 30.9% | 29.0% | 24.6% | 25.7% |

Addition 5.7 phr of a salt (magnesium chloride or guanidinium chloride) to the aqueous mixtures improved the compatibility of the PVOH and the starch, as evidenced by the decrease in the compatibility ratio (i.e., reduction in the degree of phase separation) of the salt-containing blends compared to that of the salt-free blend. Increasing the amount of magnesium chloride in the mixture from 5.7 phr to 11.4 phr further improved the compatibility of the PVOH and the starch.

### Example 2

Aqueous mixtures 2a-2d containing a blend of a PVOH polymer, a starch, plasticizers, other additives, and optionally magnesium chloride or guanidinium chloride were prepared according to the recipes in Table 2. Preparation of the mixtures included mixing for 75 minutes at a temperature in a range of 65-80° C. following addition of the hydroxyethyl-modified starch in order to gelatinize and dissolve the starch. Amounts of components are listed as parts per hundred parts of total resin content (i.e., PVOH+starch) in each mixture. Compatibility ratios between the PVOH polymer and the starch for each mixture were evaluated according to the Compatibility Test Method. Aqueous mixtures of Example 2 contain less plasticizer than aqueous mixtures of Example 1 (about 12 phr, compared to about 30-32 phr).

TABLE 2

| | 2a | 2b | 2c |
|---|---|---|---|
| PVOH homopolymer | 59.0 phr | 59.0 phr | 59.0 phr |
| Hydroxyethyl-modified starch | 41.0 phr | 41.0 phr | 41.0 phr |
| Plasticizers | 12.3 phr | 12.3 phr | 12.3 phr |
| Secondary ingredients | 2.5 phr | 2.5 phr | 2.5 phr |
| Magnesium chloride | | 5.7 phr | |
| Guanidinium chloride | | | 5.7 phr |
| Compatibility ratio | 36.4% | 30.8% | 29.2% |

Improvement in the compatibility ratio upon salt addition was also observed in the reduced plasticizer mixtures of Example 2.

Without intending to be bound by theory, the addition of salt may serve a similar function in the aqueous mixture as increasing the plasticizer level. The compatibility ratios of the salt-free mixtures, Examples 1a and 2a, indicate an improvement in PVOH/starch compatibility upon increasing the plasticizer level in the mixtures from 12.3 phr to 32.0 phr, Examples 2b and 2c show that similar improvements in PVOH/starch compatibility were attained by addition of 5.7 phr of a salt (magnesium chloride or guanidinium chloride), without changing the plasticizer level.

Because modifications and changes varied to fit particular operating requirements and environments will be apparent to those skilled in the art, the disclosure is not considered limited to the examples chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

Throughout the specification, where the compounds, compositions, articles, methods, and processes are described as including components, steps, or materials, it is contemplated that the compositions, processes, or apparatus can also comprise, consist essentially of, or consist of, any combination of the recited components or materials, unless described otherwise.

1. A water-soluble film, comprising:
a polyvinyl alcohol resin,
a starch, and
a salt,
wherein the salt is present in the film is an amount sufficient to improve the compatibility ratio of the polyvinyl alcohol resin and the starch, as determined according to the Compatibility Test Method, relative to the compatibility ratio of the polyvinyl alcohol resin and the starch in the absence of the salt.

2. The water-soluble film of claim 1, wherein the ratio of the amounts of polyvinyl alcohol resin and starch in the film is in a range of about 95:5 to about 5:95, or about 90:10 to 10:90, or about 80:20 to about 20:80, or about 70:30 to about 30:70, or about 60:40 to about 40:60.

3. The water-soluble film of claim 1, wherein the salt is selected from ammonium salts, lithium salts, sodium salts, potassium salts, calcium salts, magnesium salts, manganese salts, barium salts, iron salts, salts comprising an organic cation, and mixtures of any of the foregoing.

4. The water-soluble film of claim 3, wherein the organic cation is guanidinium.

5. The water-soluble film of claim 1, wherein the salt is selected from chloride salts, bromide salts, acetate salts, sulfate salts, nitrate salts, phosphate salts, and mixtures of any of the foregoing.

6. The water-soluble film of claim 5, wherein the salt comprises a chloride salt.

7. The water-soluble film of claim 1, wherein the salt is present in the water-soluble film in an amount in a range from about 1 to about 30 phr, or about 2 to about 25 phr, or about 3 to about 20 phr, or about 5 to about 15 phr.

8. (canceled)

9. The water-soluble film of claim 1, wherein the polyvinyl alcohol resin comprises a polyvinyl alcohol homopolymer.

10. The water-soluble film of claim 1, wherein the polyvinyl alcohol resin is present in the film in an amount in a range of about 5 wt. % to about 95 wt. %, or about 10 wt. % to about 90 wt. %, or about 20 wt. % to about 80 wt. %, or about 30 wt. % to about 70 wt. %, based on the total weight of the film.

11. The water-soluble film of claim 1, wherein at least a portion of the polyvinyl alcohol resin is bio-based.

12. The water-soluble film of claim 1, wherein the starch is selected from unmodified starches, nonionic group-modified starches, anionic group-modified starches, cationic group-modified starches, and mixtures of any of the foregoing.

13. The water-soluble film of claim 12, wherein the starch comprises a cationic group-modified starch.

14. The water-soluble film of claim 12, wherein the starch comprises a nonionic group-modified starch.

15. The water-soluble film of claim 14, wherein the nonionic-modified starch comprises a hydroxyethyl-modified starch, a hydroxypropyl-modified starch, or an octenyl succinic anhydride-modified starch.

16. The water-soluble film of claim 1, wherein the starch is present in the film in an amount in a range of about 5 wt. % to about 95 wt. %, or about 10 wt. % to about 90 wt. %, or about 20 wt. % to about 80 wt. %, or about 30 wt. % to about 70 wt. %, based on the total weight of the film.

17. The water-soluble film of claim 1, further comprising a plasticizer selected from the group of a polyol, a sugar alcohol, a polyether, an amine, and mixtures of any of the foregoing.

18. (canceled)

19. The water-soluble film of claim 17, wherein the plasticizer is selected from glycerol, diglycerin, ethylene glycol, diethylene glycol, triethyleneglycol, tetraethylene glycol, polyethylene glycols up to 400 MW, neopentyl glycol, 1,2-propylene glycol, 1,3-propanediol, dipropylene glycol, polypropylene glycol, 2-methyl-1,3-propanediol, trimethylolpropane, polyether polyols, isomalt, maltitol, sorbitol, xylitol, erythritol, adonitol, dulcitol, pentaerythritol, mannitol, ethanolamines, and mixtures of any of the foregoing.

20. The water-soluble film of claim 17, wherein the plasticizer is present in the water-soluble film in an amount in a range from about 10 to about 50 phr.

21. The water-soluble film of claim 1, further comprising one or more additives selected from fillers, surfactants, anti-block agents, antioxidants, antifoams, bleaching agents, aversive agents, pungents, other functional ingredients, and combinations of the foregoing.

22. The water-soluble film of claim 1, wherein the film, when provided at a thickness of about 76 microns, has a dissolution time of less than 300 seconds, or less than 240 seconds, or less than 180 seconds, or less than 120 seconds, as measured according to MonoSol Test Method MSTM 205 at 5° C.

23. A water-soluble article comprising a water-soluble film according to claim 1.

24. An aqueous mixture, comprising:
a polyvinyl alcohol resin;
a starch;
a salt; and
water,
wherein the salt is present is an amount sufficient to improve the compatibility ratio of the polyvinyl alcohol resin and the starch, as determined according to the Compatibility Test Method, relative to the compatibility ratio of the polyvinyl alcohol resin and the starch in an otherwise identical aqueous mixture not containing the salt.

25.-27. (canceled)

28. A method of compatibilizing a polyvinyl alcohol resin and a starch in an aqueous mixture, the method comprising adding to the aqueous mixture a salt, wherein the salt is added in an amount sufficient to improve the compatibility ratio of the polyvinyl alcohol resin and the starch in the aqueous mixture, as determined by the Compatibility Test Method, relative to the compatibility ratio of the polyvinyl alcohol resin and the starch in an otherwise identical aqueous mixture not containing the salt.

29.-40. (canceled)
